(19) United States
(12) Patent Application Publication
(10) Pub. No.: US 2025/0338354 A1
(43) Pub. Date: Oct. 30, 2025

(54) Method for setting up and/or maintaining an emergency call, and system comprising a vehicle, a server infrastructure and in each case at least one first, second and third protocol

(71) Applicant: AUDI AG, Ingolstadt (DE)

(72) Inventors: Herbert EHRENTRAUT, Beilngries (DE); Thorsten HEHN, Etting (DE); Jörg PLECHINGER, München (DE); Christoph RABHANSL, Ingostadt (DE); Stefan VOLNHALS, Adelschlag (DE)

(73) Assignee: AUDI AG, Ingolstadt (DE)

(21) Appl. No.: 19/189,398

(22) Filed: Apr. 25, 2025

(30) Foreign Application Priority Data
Apr. 25, 2024 (DE) 10 2024 111 619.6

(51) Int. Cl. H04W 76/50; H04W 4/38; H04W 4/44; H04W 76/25

(52) U.S. Cl. CPC H04W 76/50; H04W 4/38; H04W 4/44; H04W 76/25

(57) ABSTRACT

A method of setting up and/or maintaining an emergency call may include a voice connection and/or data connection between a vehicle and an emergency control center. The vehicle executes at least one first protocol to transmit connection set-up data according to the at least one first protocol between the vehicle and at least one server of a server infrastructure outside the vehicle provided for the emergency call, so that the voice connection and/or data connection is set up between the vehicle and the server infrastructure. The voice connection and/or the data connection is continued by the server infrastructure by execution of at least one second protocol via a public telephone network to the emergency control center, so that voice data and/or information data are exchanged between the vehicle and the emergency call center in each case via the emergency call.

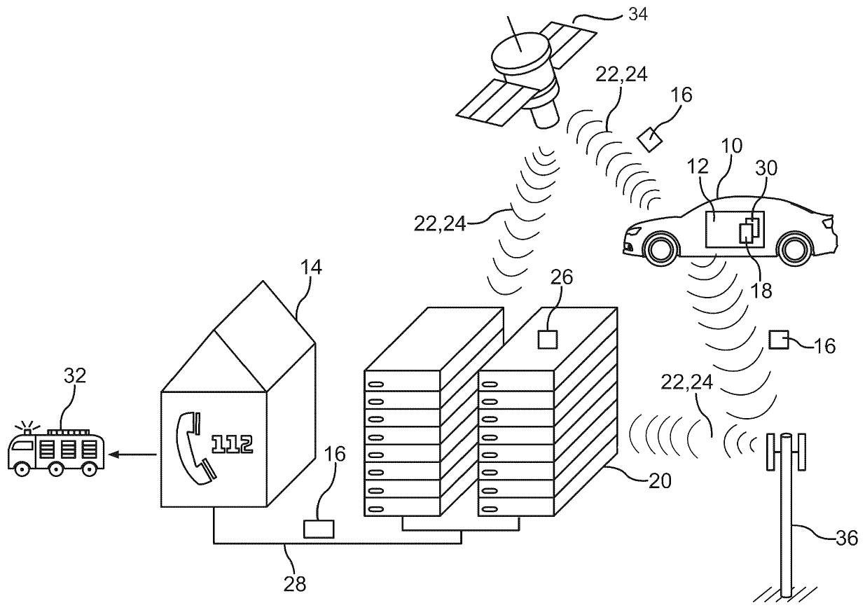

### CROSS-REFERENCE TO RELATED APPLICATIONS

This application claims the priority benefit of German Patent Application No. 10 2024 111 619.6 filed on Apr. 25, 2024, which is incorporated by reference herein in its entirety.

### BACKGROUND

### 1. Field

An invention relates to a method for setting up and/or maintaining an emergency call, according to described examples. The invention according to the examples may further relate to a system comprising at least one vehicle, a server infrastructure and at least one first protocol, at least one second protocol and at least one third protocol.

### 2. Description of the Related Art

At least all vehicles in the European Union (EU) having a type approval date as from Apr. 1, 2018 have an emergency call (eCall) function. This means that, if an emergency event is detected by a vehicle having an emergency call function, an emergency call is set up, i.e. a digital data connection and/or voice connection is set up between the vehicle and an emergency control center. Voice data and/or information data can be transmitted via this emergency call. An emergency event can occur, for example, if there is a medical emergency involving a vehicle occupant, i.e. a person in the vehicle needs medical assistance, and/or if the vehicle is involved in an accident and/or if a vehicle occupant wishes to report an accident. The emergency control center performs at least one of the following functions: answering calls when a caller has dialed an emergency number (for example, 112 in Europe, 911 in the USA), alerting emergency services such as the fire department and/or rescue service and/or supporting and/or coordinating emergency services in the event of an emergency.

Emergency calls are currently set up in the EU via Regulation (EU) 2015/758, wherein data for setting up the digital data connection and/or voice connection are processed by means of in-band signaling, i.e. by modulating data onto audio tones and by transmitting the data via an audio channel and, following a successful connection set-up, by means of a line-switched voice transmission using 2G or 3G technology. An update of this method will become mandatory for vehicles in the EU as from Jan. 1, 2026, wherein the data for the connection set-up are transmitted via a Session Initiation Protocol (SIP), i.e. a network-operator-specific protocol, and voice is transmitted via a packet-switched audio connection in the form of Voice over Long-Term Evolution (VOLTE) or Voice over New Radio (VoNR), which also requires network-operator-specific protocols and a cellular modem. The two methods described above for setting up an emergency call will be referred to below as current emergency call methods.

Further options for setting up an emergency call are described in DE 10 2022 119 837A1 and US 2017/0374538 A1. DE 10 2022 119 837 A1 discloses a method for making an emergency call in which a backend of a vehicle receives emergency call data via a wireless connection provided by a communication unit of the vehicle and makes an emergency call to a control center for the vehicle using the received emergency call data. US 2017/0374538 A1, on the other hand, describes a method in which a system in the vehicle transmits an emergency call to a server of a third-party provider who in turn forwards the data from the emergency call to the emergency control center. Communication independent from mobile radiocommunications is not disclosed, as a result of which vehicle manufacturers are forced to carry out regular tests due to possible changes to the cellular network introduced by the network operator.

### SUMMARY

The invention according to the examples is based on an example object of providing an alternative solution for setting up an emergency call, into which definable functions and/or functionalities can be integrated.

An example object may be achieved by the subject-matter of the independent patent claims. Advantageous developments of the invention according to the examples are described by the dependent patent claims, the following description and the FIGURE.

The invention according to the examples is based on the finding that, due to the dependence of current emergency call methods on the cellular network, there is, on one hand, a dependence on a network operator and, on the other hand, a dependence on standardized protocols for voice transmissions via the cellular network, as a result of which the current emergency call procedures lack flexibility with regard to the functions (functionalities) that are to be installed. This disadvantage is intended to be eliminated by the method according to examples of the invention, which uses its own server infrastructure and an Internet-based transmission.

The invention according to the examples relates to a method for setting up and/or maintaining an emergency call, said method comprising a voice connection and/or data connection between a vehicle and an emergency control center in the event that an emergency event is detected by the vehicle. This means that the vehicle can comprise at least one sensor, by which the emergency event can be detected, for example, by an airbag control unit. Additionally or alternatively, the vehicle can have an operating element, the actuation of which, for example by a vehicle occupant, can represent an emergency event. Once the emergency event has been detected by the vehicle, an emergency call can be set up. The emergency call is a voice connection and/or data connection, i.e. in particular a single connection, which is configured to transmit voice data and/or information data. This means that detected voice and/or detected sounds can be transmitted as acoustic data, and different information, such as the position of the vehicle, the number of occupants in the vehicle, information relating to the vehicle and/or the manner in which the emergency call is triggered, can be transmitted as non-acoustic data via the emergency call.

The method according to the examples of the invention is characterized in that the vehicle executes at least one first protocol, as a result of which the vehicle transmits connection set-up data as over-the-top content according to the at least one first protocol between the vehicle and at least one server of a server infrastructure outside the vehicle provided for the emergency call in order to set up the voice connection and/or data connection between the vehicle and the server infrastructure. Connection set-up data are data that are required in order to set up the voice connection and/or data connection between the vehicle and the server infrastructure. The server infrastructure comprises at least one server, in particular a plurality of servers. The server infrastructure can, for example, comprise servers in one or more data centers and/or servers that are integrated into one or more vehicles and/or servers that are provided by a cloud computing provider. The vehicle itself does not therefore contact an emergency control center directly via a telephone network for the emergency call, but instead contacts the server infrastructure that is separate therefrom.

The voice connection and/or data connection between the vehicle and the server infrastructure, which is set up by the execution of the first protocol, may be configured to transfer data, in particular the connection set-up data and/or voice data and/or information data, as over-the-top (OTT) content. This means that the voice connection and/or data connection between the vehicle and the server infrastructure is not a connection that is routed as a dedicated voice connection via the cellular network provided by a network operator. Instead, it is an over-the-top connection, also known as an OTT connection. This is an established term known from the prior art for an Internet-based connection in which data, in particular voice data, are transmitted via Internet access without an Internet service provider (ISP) being involved in the control and/or dissemination of the data. This means that the data are transmitted via an infrastructure of the Internet provider, but, in particular, only the endpoints of the Internet connection (vehicle and server) interpret the transmitted data, in particular the connection set-up data and/or voice data and/or information data, but not the ISP. This infrastructure is used only as a transmission medium, meaning that the content is not controlled by the Internet provider.

Through the execution of at least one second protocol, for example, by at least one of the servers, the voice connection and/or data connection is continued from the server infrastructure via a predetermined public telephone network to the emergency control center. This means that, through the execution of the second protocol, the over-the-top voice connection and/or data connection between the vehicle and the server infrastructure is supplemented by a voice connection and data connection between the server infrastructure and the emergency control center routed via the public telephone network. The emergency control center is therefore contacted by the server infrastructure. As a whole, the execution of the first and the second protocol results in the set-up of the emergency call, i.e. the set-up of the voice connection and/or data connection between the vehicle and the emergency control center. The emergency call is divided into two parts or connection segments, one of which is the over-the-top connection, which is configured to transmit data, in particular connection set-up data and/or voice data and/or information data, between the vehicle and the server infrastructure, and the other of which is the connection between the server infrastructure and the emergency control center routed via the public telephone network. The server infrastructure may be configured to convert the data, in particular the connection set-up data and/or voice data and/or information data, between the two connections, the over-the-top connection and the connection routed via the public telephone network, so that a continuous connection is maintained between the vehicle and the emergency control center by the server infrastructure.

In addition, examples of the invention provides that, through the execution of at least one third protocol by the vehicle and/or by the at least one server, voice data and/or information data are exchanged as over-the-top content between the vehicle and the server infrastructure and via the public telephone network between the server infrastructure and the emergency control center in each case via the voice connection and/or data connection of the emergency call. This means that the data transmitted via the emergency call, i.e. via the voice connection and/or data connection between the vehicle and the emergency control center, are the voice data and/or information data. The voice data and information data are preferably not transmitted separately via a plurality of connections.

The method according to examples of the invention offers a plurality of advantages, in particular compared with the current emergency call methods. There is therefore no need to provide protocols and/or parameters (for example VOLTE parameters and/or VoNR parameters) for each network operator, since no voice connection is set up via the cellular network. Additionally or alternatively, no retests, i.e. no repeated testing, of the emergency call function are required by the vehicle manufacturer (automobile manufacturer) in order to identify changes to the cellular network, e.g. codec changes, carried out, for example, by the network operators, and to thus ensure functionality by updating at least one protocol. This results, in particular, in savings in terms of cost and effort. Additionally or alternatively, transmissions via the cellular network are tied to predefined standards, for example to standards that can be predefined by a standardization organization, for example the 3rd Generation Partnership Project (3GPP). The 3GPP, for example, specifies methods for converting voice into data to be transmitted and vice versa, and/or specifies the codecs that are to be used for this purpose. More options are accordingly available for processing the data using the method according to examples of the invention due to the independence from the cellular network, as a result of which an improvement in the emergency call function through adaptation of the protocols and the codecs that are used specifically to the situation (in this respect, see also at least one of the dependent claims), increased customer satisfaction and the provision of a plurality of functions can be achieved.

Independence from the cellular network may imply, in particular, independence from a voice connection via the cellular network. This means that no data, in particular no connection set-up data and/or voice data and/or information data, are transmitted via the voice connection of the cellular network, which includes, inter alia, the standards 2G, 3G, 4G and/or 5G for voice connections.

The at least one first protocol that is described, and also the at least one second protocol and the at least one third protocol are communication protocols and/or network protocols as known from the prior art, i.e. agreements on how data transmission takes place between at least two parties, here between the vehicle, at least one of the servers and the emergency control center. The agreements defined by the protocol are referred to below as the protocol code. Furthermore, in the following application, the execution of a first/second/third protocol is to be understood to mean the execution of at least one first/second/third protocol. The term “first protocol” refers, in particular, to a short form of “protocol of a first predetermined protocol type”, and the same applies to “second protocol” and “third protocol”.

As already known from the prior art, the execution of such a protocol by the vehicle comprises the execution of the protocol by at least one control unit and/or a group of control units of which the vehicle is comprised.

The invention according to the examples also comprises developments which offer additional advantages.

In one development, through the execution of at least one of the at least one first protocol and/or at least one of the at least one third protocol for setting up and/or maintaining the emergency call, at least one of the following functions is provided:

a) improvement in voice quality and/or reduction of latency compared with a voice connection via a cellular network, in particular of a network operator. This can mean an improvement in voice quality and/or a reduction of latency compared with a connection set-up for which a protocol according to a mobile radio transmission standard has been used, and/or wherein the voice data and/or information data are exchanged via the voice connection of the cellular network. This means improved voice quality and/or a reduction of the delay in the transmission of the voice data and/or information data if the voice data and information data are transmitted via the emergency call according to the examples of the invention, compared with a current emergency call method. This can be achieved, for example, by using different audio codecs, in particular audio codecs which differ from the audio codecs used in the current emergency call methods and/or in the transmission of voice data via at least one mobile radio network. A codec is known from the prior art and generally describes a program which encodes and/or decodes data and/or at least a signal, in this case, for example, an audio signal, in particular to reduce a volume of data for transmission and/or to prepare said data for transmission. The audio codecs used according to the development can comprise, for example, one of the following functions:
Background noise suppression, such that sounds which do not originate from at least one person and/or which are not voice from at least one person are suppressed and/or blocked and/or not transmitted. Additionally or alternatively, the background noise suppression can include suppression and/or blocking and/or non-transmission of sounds having a volume below a definable volume, so that it can be assumed, in particular, that the sound is at a definable distance from the vehicle, for example, is located outside the vehicle, or that the sound is not voice.
Processing of the voice, i.e. processing of the sounds identified as voice, such that the voice, in particular, becomes more clearly understandable. This can comprise, for example, correcting pronunciation errors, such as lisping and/or swallowing parts of words and/or slurring words, and/or correcting pronunciation idiosyncrasies and/or replacing words attributable to dialect with synonyms. The voice processing can be performed, for example, by artificial intelligence.
Reduction of latency by audio codecs which allow faster voice processing and/or enable the amount of voice data and information data transmitted to the server infrastructure to be adjusted, for example, according to a data rate and/or bandwidth available at the scene of the emergency event.

This offers the advantage of improved communication, for example between a vehicle occupant and a person in the emergency control center, which can result in a calming of the vehicle occupant and/or in better assistance from the emergency control center, since, for example, improved voice quality removes the need for repeated questioning. Lower latency offers the advantage that two people do not attempt to speak at the same time, which also helps improve communication. Additionally or alternatively, response times during the call are reduced, which can lead to faster assistance and/or calming of the vehicle occupant.

b) An artificial-intelligence-based translation of a conversation via the emergency call between at least one vehicle occupant and the emergency control center. The language of the vehicle occupant can be determined, for example, by voice recognition and/or is defined by settings in the vehicle, so that the part of the conversation that is spoken by a person in the emergency control center can be translated into the language detected by the vehicle. Additionally or alternatively, a global navigation satellite system (GNNS) or a global positioning system (GPS) can be used to determine the country in which the vehicle is located. On this basis, the conversation part of the vehicle occupant can be translated into at least one language assigned to the respective country, so that the conversation part translated into the corresponding language arrives at the emergency control center. Precisely one language may be assigned to each country. Alternatively, a language can be assigned in each case to different regions of the country, wherein the language of the region in which the vehicle is located is selected for the translation. This has the advantage of better communication, especially at a location which is a foreign country for the at least one vehicle occupant, thus enabling faster and better assistance, since the vehicle occupant can usually portray the situation more clearly in his/her native language than in another language. At the same time, it increases customer comfort and the knowledge that the customer, as a vehicle occupant, can rely on the function even when abroad, since he/she can continue to communicate in his/her chosen language without any communication difficulties.

c) An automated resumption of the emergency call. Hanging up, for example, in particular accidentally, by the vehicle occupant and/or by a person in the emergency control center and/or due to a poor data connection and/or low bandwidth at the scene of the emergency event, can result in an interruption of the emergency call. If the emergency call is interrupted, it can be provided that the emergency call is automatically resumed, i.e. the emergency call is automatically reconnected. The automated resumption of the emergency call can be controlled, for example, by a first and/or second and/or third protocol. The automatic resumption of the emergency call can occur, for example, in one of the following cases:
If the arrival at the scene of the emergency event of at least one emergency operative, for example from the fire department and/or from the rescue service, has not yet been detected. This can be done, for example, if at least one emergency operative and/or at least one vehicle of the emergency operatives carries or has a transmitter which emits signals that can be detected by the vehicle. If the signal is detected, it can be assumed that at least one emergency operative has arrived at the scene of the emergency event. Additionally or alternatively, sound detection can be carried out, such that if the sound from a siren of an emergency vehicle is detected, in particular if this sound exceeds a definable volume, it is assumed that at least one emergency operative has arrived at the scene of the emergency event. If no emergency operative has yet been registered as having arrived at the scene of the emergency event, the emergency call can be resumed automatically if it is interrupted.
If voice is detected after the emergency call has been interrupted. The emergency call may be resumed only if voice is detected within a definable time, for example up to a maximum time of between 30 seconds and 2 minutes, and/or above a predefinable volume.
If a predefinable voice command is detected. The voice command is preferably predefined by a person through settings of the vehicle.
The automatic resumption of the emergency call has the advantage that, in the event of an interruption, there is no need for manual triggering, which may be impossible for a vehicle occupant if, for example, the occupant is trapped and/or unable to move.

d) Provision of information relating to the current status of a rescue initiated on the basis of the emergency call. The information can, for example, be presented on a display or screen in the vehicle or can be played back audibly. The information can include, for example, the current location of the rescue services, for example, presented on a map and/or by indicating a time when the emergency services are expected to reach the scene of the emergency event, the type of emergency services, i.e. the fire department and/or rescue service and/or whether registration in the emergency control center has already taken place. This offers the advantage that the occupant can be calmed down, especially since he/she is provided with as much information as possible. Information may be provided audibly only when the emergency call has ended.

e) Display, on a screen in the vehicle, of questions to be answered and/or questions still to be answered and/or information transmitted to the emergency control center. This can facilitate communication with the emergency control center.

f) Chat function for communication with the emergency control center via a keypad in the vehicle. The keypad can be presented, for example, on a display, especially a touch-sensitive display. Additionally or alternatively, the keypad of a mobile device connected to the vehicle, such as a smartphone, a smartwatch and/or a laptop can be used. This also allows, for example, people having language difficulties and/or people having language difficulties due to the accident to communicate with the emergency control center.

The functions described above are functions which cannot be provided for a connection via a cellular network, in particular for transmission of voice data and/or information data via the voice connection of the cellular network, in particular due to the standardization of the transmission via the cellular network and/or via the voice connection of the cellular network. Only by using an OTT connection and/or a connection that is independent from the cellular network and/or the voice connection via the cellular network is it possible to provide at least one of the functions described above.

One development of examples of the invention comprises network slicing of the servers of the server infrastructure. Network slicing is a term known from the prior art. Network slicing is understood to mean the splitting of a common physical infrastructure into a plurality of parallel-operated virtual networks. When applied to examples of the invention, this means that the server infrastructure is divided into a plurality of virtual networks, wherein each virtual network can have its own characteristics. A first virtual network, for example, can be adapted to the fastest possible transmission of a data volume, and a second virtual network can be adapted to the least error-prone transmission of smaller data volumes. If a first location offers a better connection and/or a larger bandwidth for data transmission than a second location, the first virtual network can be used, for example, for the voice data and/or information data of a vehicle involved in an emergency event at the first location, and the second virtual network can be used for the voice data and/or information data of a vehicle involved in an emergency event at the second location. The use of a virtual network can relate, in particular, to the transmission of the voice data and/or information data between the over-the-top connection and the connection via the public telephone network and/or to the processing and/or modification and/or supplementing of the voice data and/or information data.

The development comprises implementing at least one of the following features by network slicing of the servers of the server infrastructure:

a) At least a part of the capacity of the server infrastructure is reserved for the at least one emergency call. This means that a definable percentage, for example, at least 50%, in particular at least 80%, of the capacity of the server infrastructure is used for nothing other than at least one emergency call. This means that, even if the capacity of the server infrastructure provided for the at least one emergency call is not used at one time for at least one emergency call, no other use (apart from at least one emergency call) is made of that capacity of the server infrastructure. Server infrastructure capacity can be understood to mean the computational power of all the servers which constitute the server infrastructure and/or the total resources provided by the servers of the server infrastructure. It has the advantage that sufficient server infrastructure capacity is always available so that an emergency call can be set up reliably.

b) Priority assignments are made for different applications implemented by the server infrastructure. This means that different priorities can be assigned to the individual virtual networks created by network slicing, and/or different priorities can be assigned to different applications on a virtual network. In particular, a different priority is assigned to at least one virtual network compared with another virtual network. The priority assignment can be carried out, for example, by assigning a higher priority to the at least one virtual network which is configured to set up at least one emergency call and/or which is reserved only for setting up at least one emergency call, compared with another virtual network which is used for applications excluding the set-up of at least one emergency call and/or for further applications in addition to the set-up of at least one emergency call. Additionally or alternatively, a highest priority can be assigned to a virtual network via which an emergency call is and/or will be set up at a given time. The highest priority can be characterized in that no virtual network has a higher priority. A plurality of virtual networks can simultaneously have the highest priority.

It can be provided that a priority assignment of an emergency call is made on the basis of the determined location of the vehicle from which the emergency call is set up and/or the bandwidth available at the location of the vehicle for transmitting the emergency call and/or the severity of at least one injury to at least one vehicle occupant and/or the number of vehicle occupants. This means that a different priority can be assigned to different emergency calls. In particular, one of the virtual networks can be assigned to the emergency calls depending on their priority. The priority assignment has the advantage that preference is given to the set-up of an emergency call, so that, in particular, the fastest possible set-up of the emergency call can be guaranteed.

c) Provision of a definable bandwidth on the server infrastructure for data traffic for each emergency call is guaranteed. This means that a definable bandwidth is reserved for each emergency call on the server infrastructure, so that it can be guaranteed for each emergency call that all data, in particular all connection set-up data and/or voice data and/or information data, can be processed and/or forwarded by the server infrastructure.

In one development, a digital signal processor (DSP) is provided, which is configured:

a) to decode and/or encode (code) data and forward them over a mobile radio connection, and/or

b) to receive data via the mobile radio connection and encode and/or decode the received data.

The DSP can be provided, for example, by the vehicle. In particular, the DSP is a DSP of the type already provided in a vehicle and is used for at least one current emergency call method. The DSP may be a DSP which is and/or has been used for setting up an emergency call via a mobile radio connection and/or for a method for making an emergency call that differs from the method for making an emergency call described in this application.

According to the development, the DSP is used to decode voice and/or data captured by the vehicle so that they are output by the vehicle, and/or to encoded them so that they are transmitted to at least one of the servers of the server infrastructure. This means that voice and/or data captured by the vehicle and/or provided by the server are transmitted as signals to the DSP, for example, to the DSP of a cellular modem. This DSP decodes and/or encodes the signals transmitted to it and forwards them so that they are output in the vehicle and/or forwarded to the server infrastructure. This can have the advantage that the DSP already provided for setting up an emergency call via a mobile radio network continues to be used to decode and/or encode signals, but these signals are transmitted using the method according to examples of the invention. This results in cost savings, since at least one existing component, in this case the existing DSP, can be reused.

The data transmitted between the server infrastructure and the vehicle, in particular the connection set-up data and/or voice data and/or information data, may be transmitted and/or received via the application layer, as described by the OSI model.

In one development, different codecs are provided by at least one of the at least one first protocol or by at least one of the at least one third protocol. This means that the execution of at least one codec can be provided by executing one of the at least one first protocol and/or one of the at least one third protocol. The codec may be configured to convert detected voice, in particular voice detected by the vehicle and/or by a microphone in the vehicle, and/or information, into the data transmitted to the at least one of the servers, in particular connection set-up data and/or voice data and/or information data. This means that the codec processes the detected voice in such a way that it can be transmitted to the at least one server. Additionally or alternatively, the codec is configured to convert the data transmitted by at least one of the servers to the vehicle, in particular connection set-up data and/or voice data and/or information data, into information presented audibly and/or visually and/or haptically in the vehicle. This means that the vehicle receives the data, in particular connection set-up data and/or voice data and/or information data, from the at least one server. These data are then processed by at least one codec such that the information obtained from the data are presented visually and/or audibly and/or haptically.

From the provided codecs, the codec and/or the first and/or third protocol comprising the codec which meets at least one of the following selection criteria is used. This means that at least one codec is selected from the provided codecs by at least one of the following selection criteria, and/or at least one first protocol and/or third protocol is selected that provides the execution of the at least one codec which is selected on the basis of at least one of the following selection criteria.

According to one selection criterion, the codec is selected by at least one vehicle occupant. This can be implemented, in particular, by providing the at least one vehicle occupant with a plurality of options for definable characteristics to choose from. For example, the vehicle occupant can be offered a plurality of choices regarding the information that is to be transmitted and can be transmitted as information data, such as, for example, information relating to pre-existing medical conditions, medical information and/or technical information concerning the vehicle.

Additionally or alternatively, the codec that is used can be preset so that it is adapted as far as possible to the vehicle and, in particular, takes into account the technical characteristics of the vehicle. The codec can, for example, specifically use all information sources provided in the vehicle, i.e. all sensors, by which information relating to at least one vehicle occupant can be acquired, and/or can provide the technical data of the vehicle.

Additionally or alternatively, the selection criterion can comprise the use of the at least one codec which is the most suitable of the provided codecs due to a provided maximum rate for transmitting the connection set-up data and/or voice data and/or information data via the emergency call. This can be based on the fact that different codecs compress the data transferred to them, in particular connection set-up data and/or voice data and/or information data, to differing degrees and/or provide differing amounts of data, in particular connection set-up data and/or voice data and/or information data, for transmission to the at least one server, so that different bandwidths are required for the transmission of these data, in particular connection set-up data and/or voice data and/or information data, from the vehicle to the server and/or vice versa. The bandwidth here is a measure of the amount of data transmitted via a medium in a given unit of time. The codec that requires a lower bandwidth than the available bandwidth and for example, as a second criterion, transmits as much information as possible can be selected accordingly, depending on the bandwidth.

The most suitable codec is advantageously selected on the basis of the at least one selection criterion.

In one development, the emergency call video data, which are recorded with at least one camera recording at least the vehicle passenger compartment, are transmitted as information data from the vehicle to the emergency control center. This means that the vehicle comprises at least one camera which is configured to record at least the vehicle passenger compartment. The passenger compartment of the vehicle is understood to mean, in particular, the part of the vehicle in which people can, in particular usually, be present and/or in which seats are located. In particular, at least one camera can be a camera which is configured to provide a driver assistance system with data. According to the development, it can be provided that the video data recorded by this at least one camera are transmitted as information data to the emergency control center. This offers the advantage that video data from the passenger compartment of the vehicle that has detected an emergency event are available to the emergency control center, as a result of which more and/or more accurate information is available to the emergency control center. This has the advantage that the emergency control center can respond more effectively to the emergency event and can coordinate a correspondingly adapted rescue, for example through the deployment of special emergency personnel by the emergency control center.

Additionally or alternatively, according to the development, sensor information is transmitted as information data from the vehicle to the emergency control center, wherein the sensor information is obtained from sensor data from at least one sensor recording at least a part of the vehicle passenger compartment. The sensor can, for example, be a camera, wherein information relating to at least one vehicle occupant can be obtained from the video from said camera, for example using artificial intelligence. Additionally or alternatively, the sensor can be a sensor of a child-presence detection system and/or at least one pressure sensor in at least one seat. The sensor information can comprise, for example, one of the following elements: number of persons in the vehicle, visible injuries to the at least one person in the vehicle, indication of whether at least one person has a visible injury requiring treatment by a doctor, the availability of whom is not guaranteed in every hospital, detectability of respiratory movements of the at least one person in the vehicle, detectability of eye and/or eyelid movements of the at least one person in the vehicle.

The advantage is that information that is important for a rescue and/or for the emergency control center can be transmitted even if it is not possible for any vehicle occupant to report this to the emergency control center via an existing voice connection.

One development eliminates the need for the provision of functions, in particular an interpretation of the connection set-up data and/or voice data and/or information data by a network operator, in particular for the use of a voice connection via a facility of the network operator, and/or for the use of a Session Initiation Protocol as the first and/or third protocol and/or for the use of a Voice over Internet Protocol (VoIP-Voice over IP) as the first and/or third protocol. This means that the data, in particular the connection set-up data and/or voice data and/or information data, are transmitted independently from a network operator, i.e. independently from the cellular network, in particular from a voice connection via the cellular network. This means that, for the transmission of the data, in particular the connection set-up data and/or voice data and/or information data, a method other than transmission via the cellular network is used, in particular a method other than transmission via the voice connection via the cellular network, in particular other than transmission and/or interpretation by a network operator. Additionally or alternatively, at least one of the at least one first protocol and/or at least one of the at least one third protocol is a protocol which differs from a Session Initiation Protocol and/or a Voice over Internet Protocol as known from the prior art.

This has the advantage that protocols are not used which are subject to certain regulations and which consequently impose restrictions on what can be implemented with the protocol. This results in a wider range of applications and/or greater flexibility in the content to be transmitted and/or the way in which it is transmitted.

One development comprises the combined transmission of voice data and information data in the emergency call. This means that both voice data and information data are transmitted via a common connection.

Additionally or alternatively, packet-switched transmission of voice data and/or information data is involved. Packet-switched transmission of data is known from the prior art. The advantage of this is that a plurality of routes from the vehicle to the server infrastructure can be used, so that, in the event of a switching station failure, the emergency call can still be set up.

In one development, the voice data and/or information data are transmitted via the same connection that is used to transmit the connection set-up data. This means, in particular, that both the voice data and/or information data and the connection set-up data are transmitted via the over-the-top connection, in particular from the vehicle to the server infrastructure and/or vice versa. This has the advantage that there is no need to use a plurality of different transmission types, in particular one for setting up the connection and one for transmitting data from a transmitter to a receiver (here from the vehicle to the emergency control center and/or vice versa), so that, in particular, only one connection type is used. In particular, this simplifies the set-up of the emergency call and the transmission of the voice data and/or information data transmitted by the emergency call.

In one development, the server infrastructure is a network of servers provided specifically for the set-up and/or maintenance of at least one emergency call in each case from a vehicle to an emergency control center. This can mean, in particular, that the sole task to be performed by the servers of the server infrastructure is to set up and/or maintain the emergency call using the method according to examples of the invention.

Additionally or alternatively, the server infrastructure is a proprietary network of servers. This means, in particular, that the server infrastructure is a server infrastructure independent from the network operators. The servers of the server infrastructure can, for example, be servers of a third-party provider and/or a server infrastructure set up by a vehicle manufacturer and/or a server infrastructure or part of a server infrastructure of a cloud computing provider.

This offers the advantage of independence from the network operator.

In one development, each first and/or each third protocol is in each case a protocol which differs from the protocols predefined by a standardization organization for mobile radiocommunications. Mobile radiocommunications, i.e. the transmission of data via at least one cellular network, in particular via the voice connection of the cellular network, in particular of a network operator, are governed by certain specifications, in particular those defined by a standardization organization such as 3GPP. Each first and each third protocol, and for example each second protocol also, differs from the protocols used for mobile radiocommunications. This can be implemented because the method according to the examples of the invention may be completely independent from a transmission of data via mobile radiocommunications. This has the advantage that more functions can be implemented and the at least one protocol can be individually adapted to the emergency call, especially since the standardization specifications do not have to be complied with.

In one development, each first and/or each second protocol and/or each third protocol is in each case a protocol based on a Hypertext Transfer Protocol Secure. The Hypertext Transfer Protocol Secure is a protocol known from the prior art and offers the advantage that a reliable and/or secure Internet-based transmission of the data, in particular the connection set-up data and/or voice data and/or information data, is thereby guaranteed.

In one development, code for at least one new first protocol and/or at least one new second protocol and/or at least one new third protocol is transmitted via a wired or wireless connection to the vehicle, and/or code for at least the first protocol and/or at least the second protocol and/or at least the third protocol is modified via a wired or wireless connection. This means that a new first and/or second and/or third protocol can be transmitted to the vehicle, which adds to the number of existing first and/or second and/or third protocols and is considered equivalent to the existing first and/or second and/or third protocols. Additionally or alternatively, at least one of the first and/or second and/or third protocols can be modified so that it has a different code than before.

The code of a new first and/or second and/or third protocol can be transmitted and/or modified via a wired connection, for example in a workshop or subsidiary office. In addition, the code of a new first and/or second and/or third protocol can be transmitted and/or modified wirelessly, for example during a wireless software update. During the modification, in particular, a specific and/or parts of a specific first and/or second and/or third protocol already stored in the vehicle can be deleted and replaced with a correspondingly new and/or parts of a corresponding first and/or second and/or third protocol. In particular, the vehicle manufacturer can determine when and/or which first and/or second and/or third protocol is modified or transmitted and/or how the modification and/or transmission is carried out.

The code for a protocol comprises the data transmission agreements specified in the protocol, i.e. the commands that are executed when the protocol is executed.

The development offers the advantage that innovations can be effectively incorporated by the vehicle manufacturer. As a result, in particular, new functions can be effectively and/or simply provided for the emergency call and/or problems can be eliminated.

In one development, at least one of the at least one first protocol and/or at least one of the at least one third protocol is specific to a vehicle manufacturer of the vehicle and/or specific to a vehicle model of the vehicle and/or specific to the vehicle and/or is created and/or adapted by the vehicle manufacturer. This means that at least one of the at least one first protocol and/or at least one of the at least one third protocol is adapted to the vehicle manufacturer and/or the vehicle model and/or the vehicle itself. The conditions and/or specifications of the vehicle manufacturer and/or the vehicle model and/or the vehicle, for example the equipment, which comprises, in particular, the type and/or number and/or position of at least one, in particular all, of the sensors in the vehicle, and/or the operation of certain components can thus be specifically examined, and the at least one first and/or second and/or third protocol can be adapted accordingly. Additionally or alternatively, the vehicle manufacturer can create and/or adapt the respective protocol, i.e. modify its code, which also allows a flexible and/or specific adaptation to the vehicle model and/or vehicle. As a result, the emergency call can be made particularly effectively, for example by transmitting all of the information detectable by the vehicle to the emergency control center.

In one development, the emergency call from the vehicle to the server infrastructure is set up and/or maintained via a wireless network of a network provider using protocols other than those used for the transmission of voice data via the cellular network (2G, 3G, 4G, 5G) of the network provider. This means, in particular, an Internet-based emergency call, independent from the cellular network, in particular from the voice connection via the cellular network, as a result of which, in particular, the standards predefined for use of the cellular network do not have to be observed. In particular, the cellular network is understood to mean the 2G, 3G, 4G and/or 5G mobile radiocommunications standards known from the prior art, wherein the “G” stands for “generation” here.

For uses or applications that can arise with the method and which are not explicitly described here, it can be provided that an error message and/or a prompt to input user feedback is issued and/or a default setting and/or a predetermined initial state is defined according to the method.

As a further solution, the invention according to the examples comprises a system comprising at least one vehicle, a server infrastructure, at least one first and/or at least one third protocol and a second protocol, which are configured to carry out the method according to the examples of the invention.

The system according to the examples of the invention can comprise developments which have been described as developments of the method according to the examples of the invention. For this reason, the corresponding developments of the camera system according to the examples of the invention having a processor, and also the vehicle according to the examples of the invention are not described here again.

The control device for the vehicle also forms part of the examples of the invention. The control device can comprise a data processing device or a processor device which is configured to carry out an a method according to the examples of the invention. For this purpose, the processor device can have at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can be used in each case as a microprocessor. The processor device can further have program code which, when executed by the processor device, is configured to carry out the method according to the examples of the invention. The program code can be stored in a data memory of the processor device. The processor device can be based, for example, on at least one printed circuit board and/or on at least one SoC (system on chip).

The invention according to the examples also includes developments of the method according to the examples of the invention which have features as already described in connection with the developments of the vehicle according to the examples of the invention. For this reason, the corresponding developments of the method according to the examples of the invention are not described here again.

The vehicle according to the examples of the invention may be configured as an automobile, in particular a passenger automobile, or a truck, or as a passenger bus or motorcycle.

As a further solution, the invention according to the examples also comprises a computer-readable storage medium comprising program code, which, when executed by a computer or a computer network, causes the program code to carry out the method according to the examples of the invention. The storage medium can be provided at least partially as a non-volatile data memory (e.g. as a flash memory and/or as an SSD-solid state drive) and/or at least partially as a volatile data memory (e.g. as a RAM-random access memory). The storage medium can be arranged in the computer or computer network. The storage medium can also be operated, for example, as an App Store server and/or cloud server on the Internet. A processor circuit having, for example, at least one microprocessor can be provided by the computer or computer network. The program code can be provided as binary code and/or as assembler code and/or as source code of a programming language (e.g. C) and/or as a program script (e.g. Python).

The invention according to the examples also comprises the combinations of the features of the described examples. The invention according to the examples therefore also comprises implementations which in each case have a combination of the features of a plurality of the described examples, insofar as the examples have not been described as mutually exclusive.

### BRIEF DESCRIPTION OF DRAWINGS

Examples of the invention are described below. In this respect:

A FIGURE shows a schematic view of the method according to an example.

### DESCRIPTION

The examples of the invention are explained below. In the examples, the described components in each case represent individual features of the examples which are to be considered independently from one another and which each case develop the examples independently from one another. The disclosure is therefore also intended to comprise combinations of the features of the examples other than those illustrated. Furthermore, the described examples can also be supplemented with more of the features of the examples already described.

The same reference signs in each case denote functionally identical elements in the FIGURE.

The method shown schematically in the FIGURE is only an example. Further examples are not excluded by the following description.

The FIGURE shows an example of a vehicle 10 having a control unit 12. The control unit 12 can also be replaced by a combination of a plurality of control units 12. The vehicle 10 detects an emergency event, for example by detecting an accident and/or through manual notification by a vehicle occupant to the vehicle 10 of the presence of an emergency event. An emergency event can, for example, be a medical emergency of a vehicle occupant and/or a collision of the vehicle 10 with another vehicle and/or with an obstacle.

An emergency call can be set up once the emergency event has been detected by the vehicle 10. The emergency call is a voice connection and/or data connection between the vehicle 10 and an emergency control center 14. Connection set-up data and/or voice data and/or information data can be transmitted from the vehicle 10 via the emergency call to the emergency control center 14 and/or vice versa. The connection set-up data can be data that are required to set up the emergency call, for example, an identifier that uniquely identifies the vehicle 10. The voice data can be sounds, in particular voice, recorded, for example, by a microphone, which have been modified in such a way that they can be transmitted via the emergency call. Information data can be general information such as information relating to the vehicle and/or the location of the vehicle and/or at least one vehicle occupant. The connection set-up data and/or voice data and/or information data are referred to below as transmission data 16.

The vehicle 10, in particular the control unit 12 of the vehicle 10, executes at least one first protocol 18 in order to set up the emergency call. The vehicle 10 can have stored one or more first protocols 18 and/or can execute one or more first protocols 18 in order to set up the emergency call. The execution of a first protocol 18 is assumed by way of example below.

Through the execution of the first protocol 18 by the vehicle 10, a voice connection and/or data connection 22 is set up between the vehicle 10 and at least one server of a server infrastructure 20. This voice connection and/or data connection 22 can be set up, for example, via at least one satellite 34 and/or at least one cell phone tower 36. This voice connection and/or data connection 22 is an over-the-top connection 24, in which the transmission data 16 are transmitted as over-the-top content. In particular, the connection set-up data are also transmitted via the over-the-top connection 24, i.e. as an Internet-based transmission. The over-the-top connection 24 between the vehicle 10 and the server infrastructure 20 is extended by a telephone network connection 28 between the server infrastructure 20 and the emergency control center 14 by the execution of at least one second protocol 26, which may be executed by at least one server of the server infrastructure. The transmission data 16 can be transmitted from the server infrastructure 20 via the telephone network connection 28 over a public telephone network to the emergency control center 14. The over-the-top connection 24 and the telephone network connection 28 together with the server infrastructure 20, which represents an interface between the over-the-top connection 24 and the telephone network connection 28, form the emergency call.

Through the execution of a third protocol 30, here, for example, by the vehicle 10, transmission data 16, in particular voice data and/or information data, can be transmitted from the vehicle 10 via the emergency call to the emergency control center 14 and/or vice versa. In response to the emergency call and/or the transmission data 16 transmitted to the emergency control center 14, in particular voice data and/or information data, the emergency control center 14 can dispatch at least one emergency operative 32 to the scene of the emergency event.

The emergency call is a connection that is independent from a cellular network and therefore from a network operator. This means, in particular, that the transmission data 16 are transmitted via a connection other than via the cellular network, in particular via a connection other than via the voice connection of the cellular network, i.e., for example, 2G, 3G, 4G and/or 5G. The transmission data 16 are transmitted, in particular, over-the-top, which can be described as Internet-based, and/or via the public telephone network. This can result in independence from the network operator. This results, in particular, in the independence of the first protocol 18 and/or second protocol 26 and/or third protocol 30 from the standards that apply to protocols by which data can be transmitted via the cellular network, in particular via the voice connection of the cellular network. In particular, the independence from the cellular network, in particular the independence from the voice connection of the cellular network, results in an independence of the first protocol 18 and/or second protocol 26 and/or third protocol 30 from a Session Initiation Protocol and/or a Voice over Internet Protocol. It can be provided that the first protocol 18 and/or the second protocol 26 and/or the third protocol 30 eliminate the use of the Session Initiation Protocol and/or the Voice over Internet Protocol, i.e., in particular, do not use the structure predefined by the Session Initiation Protocol and/or the Voice over Internet Protocol and/or the predefined commands and/or the predefined standards. The standards can be predefined by a standardization organization, such as 3GPP. In particular, each first protocol 18 and/or each second protocol 26 and/or each third protocol 30 differs from the protocols for mobile radiocommunications, which are standardized, for example, by at least one standardization organization. Protocols for mobile radiocommunications are those which are executed in order to transmit data via the cellular network, in particular via the voice connection of the cellular network.

Each first protocol 18 and/or each second protocol 26 and/or each third protocol 30 can be based, for example, on the Hypertext Transfer Protocol Secure, which enables, in particular, an Internet-based transmission of the transmission data.

As a result, in particular, of the independence from the cellular network and/or from the voice connection via the cellular network and therefore as a result of the independence from standardized protocols, i.e. from protocols predefined by at least one standardization organization, functions and/or functionalities which cannot be implemented in a transmission via the cellular network, in particular in a transmission via a voice connection of the cellular network, due to the given standards, can be integrated into the emergency call according to the examples of the invention.

The method can provide that at least one codec is executed. The execution of the at least one codec can be predefined, for example, by the first protocol 18 and/or the second protocol 26 and/or the third protocol 30. The codec can be executed, for example, by the vehicle 10 and can convert the transmission data 16 into audible and/or visual and/or haptic signals which are reproduced in the vehicle. Additionally or alternatively, the codec can process signals, for example, sounds and/or information from a microphone and/or sensor, to produce the transmission data 16. These two operations (conversion of the transmission data 16 into signals and processing of the signals to produce transmission data 16) will be summarized below as data processing by at least one codec.

Since the data processing by at least one codec can be different, depending on the codec that is used, it can be provided that at least one codec is selected from a set of codecs. Since the choice of codec can be predefined in the first protocol 18 and/or the second protocol 26 and/or the third protocol 30, the codec can be chosen by selecting the first protocol 18 and/or the second protocol 26 and/or the third protocol 30. The codecs can be selected by a vehicle occupant, for example through the settings. Additionally or alternatively, the choice of codec can be set by default, for example adapted to the vehicle 10 and/or the model of the vehicle 10. Additionally or alternatively, the codec can be selected depending on the scene of the emergency event, in particular depending on the bandwidth available at the scene of the emergency event. The codec can be selected, for example, such that the bandwidth required for the codec does not exceed the bandwidth available at the scene of the emergency event.

Additionally or alternatively to the use of at least one codec, the transmission data 16 and/or data captured by the vehicle 10 can be encoded and/or decoded by a DSP. The DSP may be a DSP of the type used to encode and/or decode data captured by the vehicle 10 for subsequent transmission of the data via the cellular network and/or to encode and/or decode data received via the cellular network. However, instead of transmitting the data via the cellular network and/or receiving the data via the cellular network, the reception of the transmission data 16 and/or the transmission from the vehicle 10 as transmission data 16 are performed via the over-the-top connection 24. An already existing DSP provided for transmission via the cellular network can be reused in the method according to the examples of the invention.

By the method according to the examples of the invention, in particular by at least one first protocol 18 and/or at least one second protocol 26 and/or at least one third protocol 30, at least one of the following functions can be provided:
an improvement in voice quality and/or a reduction of latency compared with a voice connection via the cellular network, and/or
a translation of the conversation via the emergency call based on artificial intelligence, and/or
an automated resumption of the emergency call, and/or
provision of up-to-date information relating to the current status of the at least one emergency operative 32, and/or
display, on a screen in the vehicle, of questions to be answered and/or questions still to be answered and/or information data transmitted to the emergency control center 14, and/or
chat function for communication with the emergency control center 14 via a keypad in the vehicle 10, and/or
transmission of video data from at least one camera recording the passenger compartment of the vehicle 10 from the vehicle 10 to the emergency control center 14, and/or
transmission of information which has been determined by at least one sensor in the vehicle 10 from the vehicle 10 to the emergency control center 14, wherein the information can be information concerning at least one vehicle occupant.

The first protocol 18 and/or the second protocol 26 and/or the third protocol 30 can, in particular, in each case be a protocol which is specifically adapted to the vehicle manufacturer of the vehicle 10 and/or to the vehicle model of the vehicle 10 and/or to the vehicle 10 itself. This means that the characteristics of the vehicle manufacturer and/or vehicle model and/or vehicle 10 are examined and these characteristics are taken into account so that, if possible, all available information can be transmitted via the emergency call. In particular, each first protocol 18 and/or each second protocol 26 and/or each third protocol 30 can be predefined by the vehicle manufacturer.

In an example, at least one first protocol 18 and/or at least one second protocol 26 and/or at least one third protocol 30 can be modified and/or added, in particular by the vehicle manufacturer. As a result, for example, new functions can be provided for the emergency call and/or problems can be resolved. The modification and/or addition (the new transmission) of at least one first protocol 18 and/or at least one second protocol 26 and/or at least one third protocol 30 can be performed, for example, via a wired connection, for example to a mobile terminal device, in particular a laptop, in a workshop and/or subsidiary office, and/or by a remote connection, i.e. via a wireless connection.

The server infrastructure 20 comprises, in particular, servers which are provided specifically to set up and/or maintain the emergency call, i.e. which do not, in particular, perform any other task. The server infrastructure 20 is, for example, a proprietary network of servers, for example, a network of servers provided by the vehicle manufacturer.

A method known from the prior art as network slicing can be used on the servers of the server infrastructure 20. All of the servers which, in particular, form the server infrastructure 20, are divided here into a plurality of virtual networks, which can have different characteristics. As a result, at least a definable part of the capacity of the server infrastructure 20 can be kept reserved, i.e. permanently provided, for the set-up and/or maintenance of at least one emergency call. Additionally or alternatively, priority assignments can be made, for example for the virtual networks, the applications executed on at least one virtual network and/or the emergency calls. Additionally or alternatively, it can be guaranteed through network slicing that a definable bandwidth is available for each emergency call, so that, in particular, a definable volume of transmission data 16 can be transmitted for each emergency call.

In particular, it can be provided that the connection for transmitting the connection set-up data is used for transmitting the voice data and/or information data and/or that the transmission of the transmission data 16 is a packet-based transmission.

An example is described below.

The eCall function has the task of setting up a digital data connection and/or voice connection in an emergency in order to inform an emergency control center. The eCall function can be triggered in various ways, for example manually by a user, for example a vehicle occupant, for example in the event of a medical emergency, and/or automatically by the vehicle, for example to notify the emergency control center of an accident. Important information such as the position of the vehicle, the number of occupants and the type of drive of the vehicle (internal combustion engine/electric vehicle) can be transmitted via the eCall to the control center.

In order to automatically trigger the eCall function, the airbag control unit, for example, detects the accident and sends a message relating to this event, along with further messages if necessary, to a connectivity unit on which the eCall function is running.

The eCall function is mandatory in the EU for all vehicles with a type approval date as from Apr. 1, 2018. An update to the Next-Gen NG eCall will be mandatory throughout the EU as from Jan. 1, 2026.

The emergency call according to the examples of the invention is based on the eCall function and can comprise, in particular, at least some of the features of the eCall function described above.

Current emergency call methods are based on the eCall function. The current emergency call methods use a cellular modem to implement the data transmission and voice telephony. In the case of the EU eCall according to Regulation (EU) 2015/758, data are transmitted via inband signaling (modulation of a data signal onto tones within the audio spectrum and voice is transmitted via the audio channel, similar to e.g. fax transmission) and voice is transmitted via line-switched voice transmission using 2G/3G technology. In the case of the EU eCall via the EU CO TBD, which, as from 2024, represents an update of the EU eCall in accordance with Regulation (EU) 2015/758, data are transmitted via the SIP protocol (SIP=Session Initiation Protocol), i.e. via a mobile-provider-specific and/or network-operator-specific protocol, and voice is transmitted via a packet-switched audio connection, which is a service of a mobile provider (mobile operator) and/or network operator and which is, for example, Voice over Long-Term Evolution (VOLTE) and/or Voice over New Radio (VoNR).

The current emergency call methods are prone to errors and require a high level of security. The reasons for this may include the following:
The VOLTE and/or VoNR implementations of the mobile providers and/or network operators differ significantly. The operation must therefore be secured individually for each user country and each mobile provider and/or network operator.
Updates and changes made by the mobile provider and/or network operator to the VOLTE and/or VoNR can result in malfunctions. This requires retests by the client (vehicle manufacturer).
As it is unclear to mobile customers and/or vehicle manufacturers when mobile operators and/or network operators make changes, continuous retesting by the vehicle manufacturer is necessary.

The current emergency call methods have further limitations, such as, for example:
limited robustness, as no free choice of call and/or data flow and/or reconnects and/or audio codes is possible, and/or
only a limited scope is provided, such as, for example, no additional ACKs (acknowledgment of a received request and/or response) on the application layer and/or continuous status updates.

The method according to the examples of the invention comprises a data-based “over-the-top” emergency call function. This is based on a client-server principle and/or uses the data connection to transmit the voice channel and/or the payload data. The above-mentioned proneness to errors and dependency on the mobile provider and/or network operator are thereby eliminated. The method can offer at least one of the following advantages:
increased voice quality and lower latency, especially through the use of newer audio codecs than those predefined by the mobile operator and/or network operator,
post-processing in the backend, including Al-based translation,
more stringent reconnect mechanisms than those used in mobile-operator-based and/or network-operator-based telephony,
additional status information to indicate progress,
introduction of a chat function into the emergency call function (support of customers and/or vehicle occupants with limitations),
priority assignments through network slicing enable higher quality of service than with a previous vendor-specific emergency call (or special bearer).

Additionally or alternatively, the method according to the examples of the invention can comprise using the existing digital signal processing of the cellular modem and transmitting it via the application layer to the server infrastructure.

The method according to the examples of the invention can comprise a first protocol, which is based, for example, on a Hypertext Transfer Protocol Secure (HTTPS). An example of a protocol design for the first protocol comprising an https request-response pair for configuring an emergency call is set out below:
HTTPS service retrieve_ecall_config:
   (Request) UTC Timestamp
   (Request) Installed version of config—32 bit integer (
   Request) Installed version of ConMod SW—32 bit integer
   (Request) Installed version of ConMod SW part number—32 bit integer
   (Request) VIN—String
   (Request) DTC Codes 0075—string
   (Request) ecall state information—enum {DISABLED, DISARMED, ARMED}
   (Request) DTC ZDC/Dataset Version—string
   (Response) http 200 OK/http 304 NOT MODIFIED
   (Response) Vehicle MSISDN—String
   (Response) Data transmission priority order—array of enums with enum {INBAND, SMS, SIP, IP}
   (Response) Data configuration
      SMS: number of recipients-4 bit integer
      SMS: target numbers-array of strings
      IP: data connection number of recipients-4 bit integer
      IP: data connection target URIs-array of strings
   (Response) Voice Call Method Priority Order-array of enums with enum {MNO_DYNAMIC, MNO_STATIC, OTT, EU, NG}
   (Response) Voice call configuration
      (mno _*): Target phone number: string
      (mno _*): Call flags CS, VOLTE, VONR: [boolean boolean boolean]
      (ott): target_url
      (ott): target_port
      (ott): protocols (Question. Do we carry out dynamic protocol negotiation)?
   (Response) ecall complete configuration
   (Response) Prioritized APN configuration/data bearer info

On the whole, the examples show how an over-the-top emergency call (OTT emergency call) can be provided.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. A method of setting up and/or maintaining an emergency call including a voice connection and/or data connection between a vehicle and an emergency control center, in event that an emergency event is detected by the vehicle, the method comprising:
executing, by the vehicle, at least one first protocol, as a result of which the vehicle transmits connection set-up data as over-the-top content (OTT content) according to the at least one first protocol between the vehicle and at least one server of a server infrastructure provided outside the vehicle for the emergency call, to set up the voice connection and/or the data connection between the vehicle and the server infrastructure configured to transmit the OTT content, so that the voice connection and/or the data connection is continued by the server infrastructure by at least one second protocol via a public telephone network to the emergency control center; and
executing, by the vehicle and/or by the at least one server, at least one third protocol to exchange voice data and/or information data as OTT content between the vehicle and the server infrastructure and executing the at least one third protocol to exchange the voice data and/or the information data via the public telephone network between the server infrastructure and the emergency control center, in each case via the voice connection and/or the data connection of the emergency call.

2. The method according to claim 1, wherein, the execution of the at least one first protocol and/or the at least one third protocol to set up and/or maintain the emergency call provides at least one function among functions including:
a function that improves voice quality and/or reduction of latency,
an artificial intelligence-based translation of a conversation via the emergency call between at least one vehicle occupant and the emergency control center,
an automated resumption of the emergency call,
information relating to a current status of a rescue initiated on basis of the emergency call,
a display, on a screen in the vehicle, of questions to be answered and/or questions still to be answered and/or information transmitted to the emergency control center, and/or
chat function for communication with the emergency control center via a keypad in the vehicle.

3. The method according to claim 1, wherein, by network slicing of servers of the server infrastructure:
at least a part of a capacity of the server infrastructure is reserved for the emergency call, and/or
priority assignments are made for different applications performed by the server infrastructure, and/or
provision of a definable bandwidth on the server infrastructure is guaranteed for data traffic for the emergency call.

4. The method according to claim 1, wherein a digital signal processor, which is configured:
to decode and/or encode data and forward the data via a cellular connection, and/or
to receive data via the cellular connection and encode and/or decode the data received,
decodes voice and/or data captured by the vehicle so that voice data and/or the data as decoded are output in the vehicle, and/or encodes voice and/or data provided by the at least one server of the server infrastructure so that voice data and/or the data as encoded are transmitted to at least one server of the server infrastructure.

5. The method according to claim 4, wherein different codecs are provided by at least a first protocol of the at least one first protocol and/or by at least a third protocol the at least one third protocol, to convert captured voice and/or information into data transmitted to the at least one server and/or for converting data transmitted by the at least one server to the vehicle into information presented audibly and/or visually and/or haptically in the vehicle, and
from the different codecs, a codec and/or the first protocol and/or the third protocol comprising the codec is used which:
is selected by at least one vehicle occupant, or
is preset, or
is a most appropriate of the different codecs due to a provided maximum rate for transmitting the connection set-up data and/or the voice data and/or the information data via the emergency call.

6. The method according to claim 1, wherein the emergency call comprises:
transmitting video data which are recorded with at least one camera recording at least a vehicle passenger compartment from the vehicle to the emergency control center as the information data, or
transmitting sensor information from the vehicle to the emergency control center as the information data, wherein the sensor information is obtained from data from at least one sensor scanning at least a part of the vehicle passenger compartment,
the sensor information includes at least one information element from among information elements indicating:
a number of persons in the vehicle,
visible injuries to at least one person among the number of persons in the vehicle,
indication of whether at least one person among the number of persons has a visible injury requiring treatment by a doctor, availability of whom is not guaranteed in every hospital,
detectability of respiratory movements of at least one person among the number of persons in the vehicle, and
detectability of eye and/or eyelid movements of at least one person among the number of persons in the vehicle.

7. The method according to claim 2, wherein the execution of at least the at least one first protocol and/or the at least one third protocol to set up and/or maintain the emergency call, results in provision of the functions without a network operator and/or use of a Session Initiation Protocol as the at least one first protocol and/or the at least one third protocol (30) and/or use of a Voice over Internet Protocol as the at least one first protocol and/or the at least one third protocol.

8. The method according to claim 1, wherein the voice data and the information data are transmitted together in the emergency call and/or a transmission is a packet-switched transmission of the voice data and/or the information data and/or the voice data and/or the information data are transmitted via same connection as the connection set-up data.

9. The method according to claim 1, wherein the server infrastructure is a network of servers provided to set up and/or maintain at least one emergency call in each case from a vehicle to the emergency control center, and/or the server infrastructure is a proprietary network of servers.

10. The method according to claim 1, wherein each first protocol of the at least one first protocol and/or each third protocol of the at least one third protocol is in each case a protocol which differs from protocols defined by a standardization organization for mobile radiocommunications.

11. The method according to claim 1, wherein each first protocol of the at least one first protocol and/or each second protocol of the at least one second protocol and/or each third protocol of the at least one third protocol is a protocol based on a Hypertext Transfer Protocol Secure.

12. The method according to claim 1, wherein code for at least one new first protocol for the at least one first protocol and/or at least one new second protocol for the at least one second protocol and/or at least one new third protocol for the at least one third protocol is transmitted via a wired or wireless connection to the vehicle and/or code for the at least one first protocol and/or the at least one second protocol and/or the at least one third protocol is modified via a wired or wireless connection.

13. The method according to claim 1, wherein a first protocol of the at least one first protocol and/or a third protocol of the at least one third protocol:
is specific to a vehicle manufacturer of the vehicle, and/or specific to a vehicle model of the vehicle and/or specific to the vehicle, and/or
is created and/or adapted by the vehicle manufacturer.

14. The method according to claim 1, wherein the emergency call from the vehicle to the server infrastructure is made via a wireless cellular network of a mobile provider with protocols other than those used for transmission of voice data via the wireless cellular network of the mobile provider.

15. A system comprising at least one vehicle, a server infrastructure, at least one first protocol and/or at least one third protocol and a second protocol which are configured to carry out the method according to claim 1.
